(19) United States
(12) Patent Application Publication
(10) Pub. No.: US 2019/0102156 A1
(43) Pub. Date: Apr. 4, 2019

(54) Streamlined Technique For Deploying Application In Cloud Computing Environment

(71) Applicant: Compuware Corporation, Detroit, MI (US)

(72) Inventor: David KENNEDY, Detroit, MI (US)

(21) Appl. No.: 15/890,695

(22) Filed: Feb. 7, 2018

Related U.S. Application Data
(60) Provisional application No. 62/565,184, filed on Sep. 29, 2017.

(51) Int. Cl. G06F 8/61; H04L 29/06; G06F 21/53; G06F 9/50; G06F 9/455

(52) U.S. Cl. CPC G06F 8/61; H04L 63/10; H04L 67/10; G06F 9/5077; G06F 9/45508; G06F 21/53

(57) ABSTRACT

A method is provided for emulating a mainframe development application in a secure partition of computing resources in a cloud computing environment. Privileges are granted to an execution configurator to access services in the secure partition of the cloud computing environment. The services include an application streaming service that emulates the mainframe development application on a web browser. A given instance of the application streaming service is instantiated by the execution configurator in the secure partition of the computing resources. Computing infrastructure which implements the application streaming service is configured by the execution configurator. In particular, the computing infrastructure is configured by generating a script and executing the script in the secure partition of the cloud computing environment, where the script interacts with the given instance of the application streaming service via a command-line interface of a software development kit for the application streaming service.

### CROSS-REFERENCE TO RELATED APPLICATIONS

This application claims the benefit of U.S. Provisional Application No. 62/565,184, filed on Sep. 29, 2017. The entire disclosure of the above application is incorporated herein by reference.

### FIELD

The present disclosure relates to a streamlined technique for deploying an application in a cloud computing environment and, more specifically, a method and a system for deploying a mainframe development application in a cloud computing environment.

### BACKGROUND

Mainframe systems are self-contained processing centers that are configured to perform large-scale information processing, support numerous users and application programs concurrently accessing numerous resources, and manage large amounts of information stored in databases. Accordingly, large entities may often implement a mainframe system as a primary server in its distributed server farm.

Mainframe system developers may use, for example, an Eclipse-based integrated development environment (IDE), such as Topaz Workbench provided by Compuware®, for software development of the mainframe systems. As an example, an administrator of the mainframe system may provide access to the IDE by installing the mainframe development applications on each desktop computer of the mainframe system developers. However, as a result of multiple new releases of the mainframe development applications, there may be delays in getting each of the mainframe system developers equipped with the new releases, thereby causing lost productivity and decreased efficiency with respect to mainframe system development.

This section provides background information related to the present disclosure which is not necessarily prior art.

### SUMMARY

This section provides a general summary of the disclosure, and is not a comprehensive disclosure of its full scope or all of its features.

A method is provided for emulating a mainframe development application in a secure partition of computing resources in a cloud computing environment. Privileges are granted to an execution configurator to access services in the secure partition of the cloud computing environment. The services include an application streaming service that emulates the mainframe development application on a web browser. A given instance of the application streaming service is instantiated by the execution configurator in the secure partition of the computing resources. Computing infrastructure which implements the application streaming service is also configured by the execution configurator. In particular, the computing infrastructure is configured by generating a script and executing the script in the secure partition of the cloud computing environment, where the script interacts with the given instance of the application streaming service via a command-line interface of a software development kit for the application streaming service. Configuring infrastructure included selecting a geographical location of a server on which to deploy the application streaming service; allocating computing resources for the application streaming service in the secure partition; creating a logical domain that controls user access to allocated computing resources; and associating the logical domain to the allocated computing resources.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an example mainframe development system according to the present disclosure.

FIG. 2 is an illustration of an example mainframe development system and a cloud computing environment according to the present disclosure.

FIG. 3 is a flowchart of a method for emulating a mainframe development application in a cloud computing environment according to the present disclosure.

FIG. 4 is an illustration of an example secure partition in a cloud computing environment that includes an execution configurator interacting with an application streaming service according to the present disclosure.

FIG. 5 is a flowchart of an example method for configuring computing infrastructure that implements an application streaming service according to the present disclosure.

FIG. 6 is a block diagram of a secure partition of a cloud computing environment according to the present disclosure.

FIG. 7 is a flowchart of an example scaling policy according to the present disclosure.

FIG. 8 is a flowchart of an example method for executing a script in a secure partition of a cloud computing environment according to the present disclosure.

FIG. 9 is a flowchart of an example method describing a client device interacting with a given instance of the application streaming service according to the present disclosure.

FIG. 10 is a block diagram of an example mainframe development system and an example cloud computing environment according to the present disclosure.

Corresponding reference numerals indicate corresponding parts throughout the several views of the drawings.

### DETAILED DESCRIPTION

Example embodiments will now be described more fully with reference to the accompanying drawings.

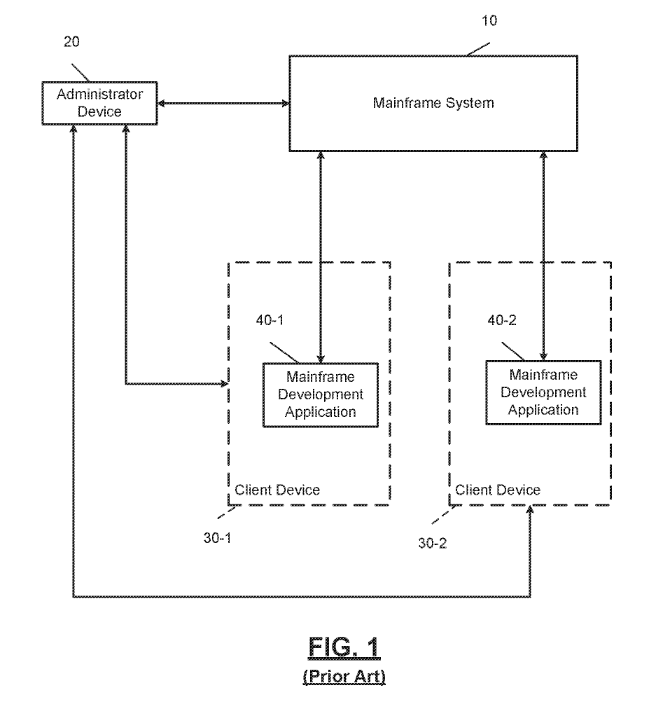

In FIG. 1, an illustration of an example mainframe development system 10 is shown. In this example embodiment, a first client device 30-1 includes a first copy of a mainframe development application 40-1, and a second client device 30-2 includes a second copy of the mainframe development application 40-2. In order for client devices 30 to receive mainframe development applications 40, an administrator, using an administrator device 20, may provide the client devices 30 software installation packages associated with the mainframe development applications 40. Subsequently, users of the client devices 30 may install the mainframe development applications 40. Likewise, the administrator may also provide software updates of the mainframe development applications 40 to the client devices 30 by providing software installation packages associated with a new version of the mainframe development applications 40.

Mainframe developers, using the mainframe development applications 40 of the client devices 30, may configure and program the mainframe system 10 to perform various functions. As an example, using the mainframe development applications 40, which may be the Topaz Workbench provided by Compuware®, mainframe developers can visualize application logic and data relationships and make changes to, test, debug, and tune code. Furthermore, mainframe developers may leverage existing Eclipse frameworks and integrations with various distributed platform tools, manage source and promote artifacts through the development lifecycle, and leverage a multi-language, multi-platform source code editor. Furthermore, mainframe developers may use JES functions (i.e., job submission, review, print, purge, etc.), manage datasets (i.e., allocation, compression, deletion), copy files from one LPAR to another LPAR, and leverage integrations with other tools.

The mainframe system 10 may be implemented by a computing infrastructure that includes one or more processors that are configured to execute instructions stored in a nontransitory computer-readable medium, such as a read-only memory (ROM) or a random-access memory (RAM). Furthermore, the one or more processors may be characterized by their function, such as a one for normal work (e.g., a CP), an integrated facility for Linux (IFL), etc. Additionally, the mainframe system 10 may include a plurality of peripheral devices, such as direct access storage devices, magnetic tape drives, control circuits, and interfaces for multiple I/O channels. The mainframe system 10 may be implemented by at least one of a z/OS, z/VM, z/VSE, Linux for zSeries, z/TPF, and other similar operating systems.

The administrator device 20 and the client devices 30 may be any computing device that includes one or more processors that are configured to execute instructions stored in a nontransitory computer-readable medium, such as a read-only memory (ROM) or a random-access memory (RAM). As an example, the administrator device 20 and the client devices 30 may be a desktop computer, laptop, mobile device, PDA, or other similar device.

The mainframe development applications 40 may be software products that cause the client devices 30 to perform a function. The functions of the mainframe development applications 40 may be accessed using native application editions of the software and/or web applications of the software. As an example, the mainframe development applications 40 may be software applications that enable mainframe developers to access and modify the mainframe system 10.

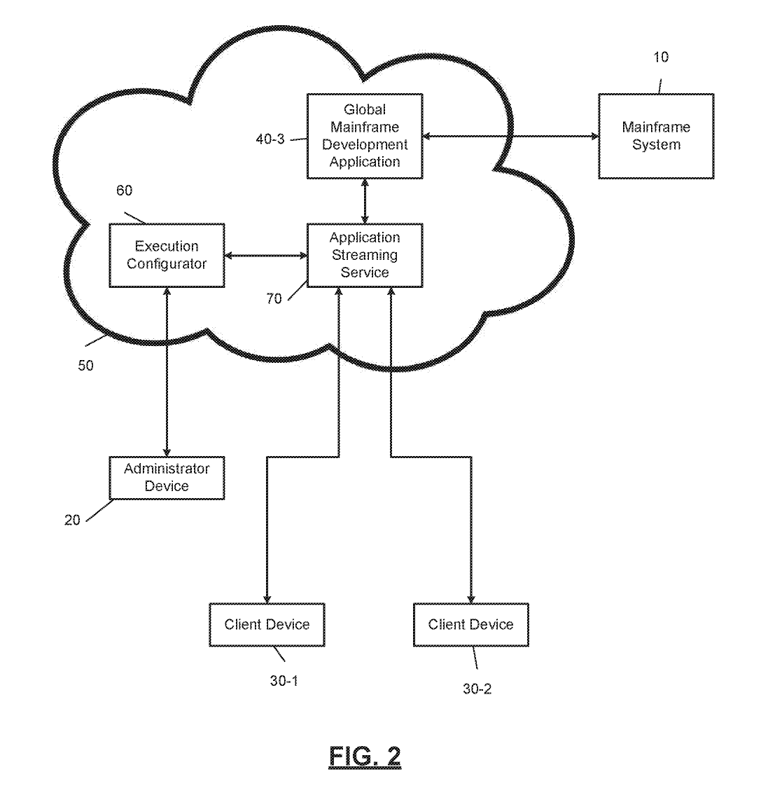

FIG. 2 illustrates an example mainframe development system 10 and a cloud computing environment 50. The cloud computing environment 50 may be a cloud service that is configured to allow a user to perform cloud computing operations. Specifically, the cloud computing environment 50 implements a plurality of virtual computers that are accessible by the client devices 30 and enable mainframe developers to modify the mainframe system 10. In one example embodiment, the administrator, using the administrator device 20, may deploy, using an execution configurator 60, a mainframe development application 40-3 (e.g., Topaz Workbench provided by Compuware®) via an application streaming service 70. Mainframe developers, using the client devices 30, may then access the mainframe development application 40-3 by using a web browser.

The cloud computing environment 50 may include one or more processors that are configured to execute instructions stored in a nontransitory computer-readable medium, such as a read-only memory (ROM) or a random-access memory (RAM). As an example, the cloud computing environment 50 may be implemented by Amazon Elastic Compute Cloud (EC2) provided by Amazon Web Services®. Alternatively, the cloud computing environment 50 may be implemented by the Google® Compute Engine, Microsoft® Azure, or other similar cloud computing environments.

The execution configurator 60 of the cloud computing environment 50 is configured to provide mainframe developers and administrators the ability to create and manage templates, and any dependencies or runtime parameters associated with the templates, which configure the computing infrastructure of the cloud computing environment 50. Additionally, the execution configurator 60 can deploy and/or update a template and its associated collection of resources by using an application programming interface (API), such as JSON or YAML templates. As an example, the execution configurator 60 may be implemented by Amazon Web Services® Amazon CloudFormation.

An application streaming service 70 of the cloud computing environment 50 is configured to stream a mainframe development application 40-3 to the client devices 30 via an HTML5 web browser of the client devices 30. The application streaming service 70 may stream the mainframe development application 40-3 to the client devices 30 for mainframe development regardless of an operating system type of the client devices 30 (e.g., Microsoft Windows®, Unix®, OS X®, and Linux®). Additionally, the application streaming service 70 enables administrators to maintain a single version of the mainframe development application (i.e., the mainframe development application 40-3) for every mainframe developer and provide remote access to the mainframe development application 40-3.

Furthermore, the application streaming service 70 provides a secure working environment for mainframe developers, as applications and data remain on the cloud computing environment 50. In other words, the application streaming service 70 may stream encrypted pixels to the client devices 30, and the mainframe development application 40-3 is executed using a streaming instance dedicated to a corresponding mainframe developer, thereby ensuring that computing resources are not shared. As an example, the application streaming service may be implemented by Amazon Web Services® Amazon AppStream 2.0.

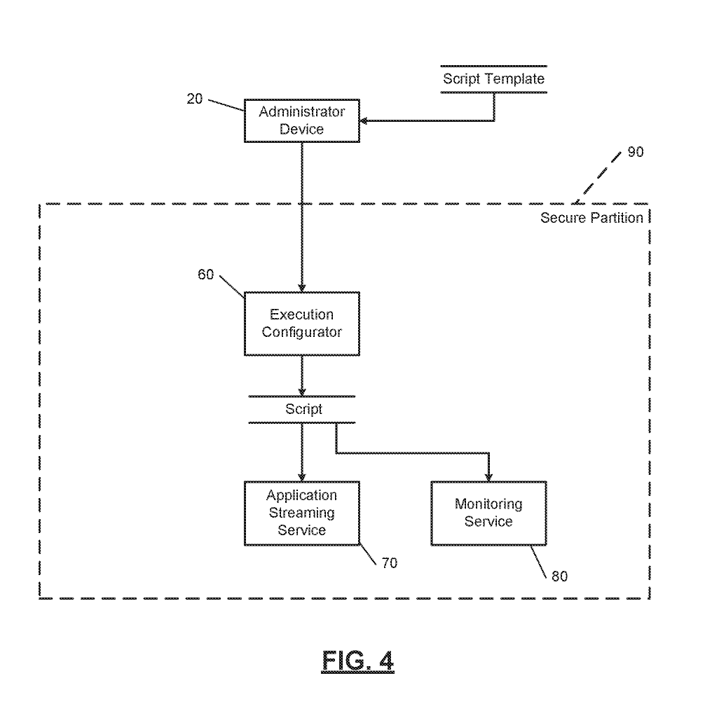

Additionally or alternatively, the cloud computing environment 50 may implement a monitoring service (not shown) that is configured to monitor an amount of computing resources the client devices 30 are consuming at a given time. As an example, the monitoring service may measure and provide metrics corresponding to CPU utilization, data transfer, and disk usage activity of the instances generated by the cloud computing environment 50. The monitoring service may be implemented by Amazon Web Services® CloudWatch. The monitoring service is described below in further detail in FIG. 4.

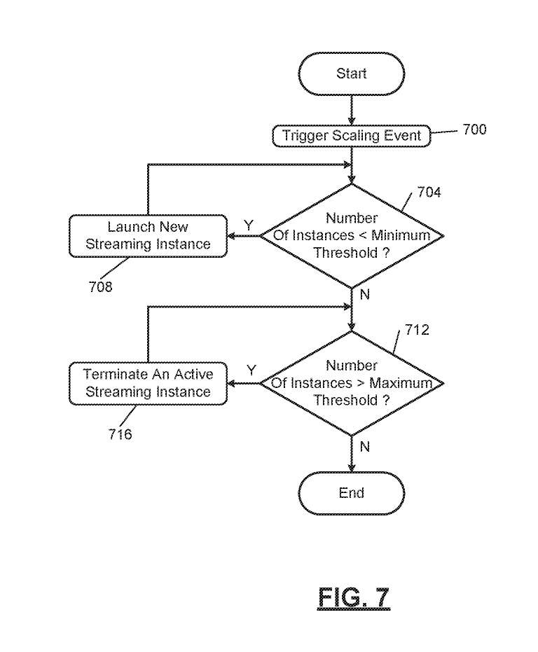

Furthermore, the monitoring service may be configured to set alarms based on an autoscaling policy, which may be defined as an algorithm for scaling the amount of computing resources of the cloud computing environment 50 based on a number of active instances. In response to triggering an alarm, the monitoring service may send notifications and/or terminate/create instances based on the autoscaling policy. Example autoscaling policies are described below in further detail in FIG. 7.

Using the cloud computing environment 50 to develop the mainframe system 10 provides numerous benefits. As an example, administrators can incorporate additional functions or capabilities to their core systems that are written in COBOL and other codebases. Leveraging the cloud computing environment 50 to incorporate these additional functions to their core COBOL applications enables mainframe developers to quickly and easily modify the mainframe system 10.

As another example, using the cloud computing environment 50, the administrator is able to deploy the mainframe development application 40-3 in a very short period of time. Furthermore, mainframe developers can access the mainframe development application 40-3 regardless of the operating system of the client devices 30 by using a web browser.

As another example, using the cloud computing environment 50, mainframe developers are able to avoid lost productivity that occurs when they do not have access to the latest version of the mainframe development applications 40. Streaming multiple instances of the mainframe development application 40-3 to each mainframe developer via the client devices 30 ensures that each mainframe developer is equipped with the latest version of the mainframe development application. Accordingly, in order to update the client devices 30, the administrator must simply update the mainframe development application 40-3 via the cloud computing environment 50.

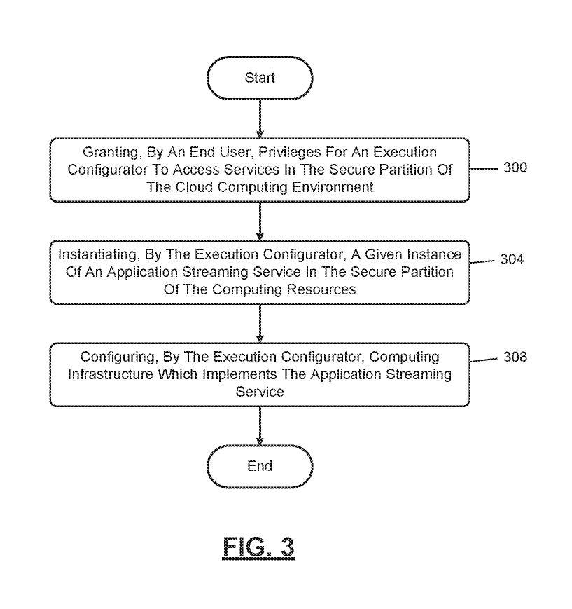

FIG. 3 illustrates a flowchart describing a method for emulating the mainframe development application 40-3 in the cloud computing environment 50. The method begins at 300, where an end user grants privileges for the execution configurator 60 to access services in a secure partition of the cloud computing environment 50. The services include the application streaming service 70 that emulates the mainframe development application on a web browser. At 304, the execution configurator 60 instantiates a given instance of the application streaming service 70 in the secure partition of the computing resources, where the application streaming service is accessible to the administrator device 20 and/or the client devices 30. At 308, the execution configurator 60 configures the computing infrastructure that implements the application streaming service 70 by generating a script and executing the script in the secure partition of the cloud computing environment 50. In one embodiment, the script interacts with the given instance of the application streaming service via a command-line interface of a software development kit for the application streaming service. Step 308 is described below in further detail in FIG. 4.

In FIG. 4, a block diagram of an example secure partition 90 of the cloud computing environment 50 and an execution configurator 60 interacting with an application streaming service 70 is shown. As described above, the execution configurator 60 configures the computing infrastructure that implements the application streaming service 70 by generating and executing a script in the secure partition 90 of the cloud computing environment 50.

In one example embodiment, the administrator device 20 obtains a script template, which may be in a JSON or YAML format. As an example, a developer of the mainframe development application 40-3, such as Compuware® Corporation, may provide a YAML template on a website. The administrator of an entity that includes a mainframe system 10, such as an IT administrator of a bank, may then download the YAML template using the administrator device 20. Subsequently, the IT administrator, using the administrator device 20, may define the parameters of the script template in order to deploy the mainframe development application 40-3 (e.g., Topaz Workbench provided by Compuware® Corporation).

Using the above example, the IT administrator of the bank may define parameters of the script template corresponding to an image. An image may be defined as information that is required to launch a streaming instance, and an image may include information corresponding to an operating system, an application server, and an application to be deployed. An image may be implemented by, for example, Amazon Machine Images provided by Amazon Web Services®.

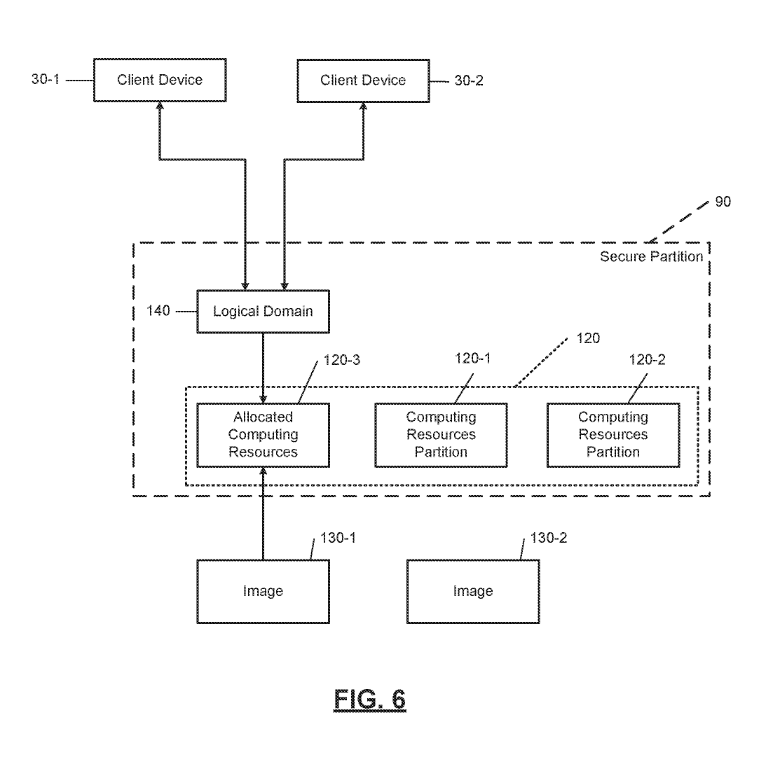

As a more specific example, the IT administrator of the bank may define the parameters corresponding to the image such that the application streaming service 70 emulates the Topaz Workbench provided by Compuware® Corporation when a user, such as a mainframe developer of the bank, launches an instance. Images are described below in further detail in FIG. 6. If the secure partition 90 is located within the Amazon Web Services® Cloud Computing Services, an example portion of the script template corresponding to the image is provided below:

ImageName:

#Type: AWS:AppStream::Image::Id
Type: String
Description: Copy the Topaz Image name string from the AppStream
Image Builder.
MinLength: 1
AllowedPattern: “\hat{ }[a-zA-z0-9-._]*$”

Additionally, the IT administrator of the bank may define parameters corresponding to a maximum user duration. The maximum user duration may be defined as the maximum allowed time a user, such as the mainframe developer of the bank, can be attached to a streaming instance. If the secure partition 90 is located within the Amazon Web Services® Cloud Computing Services, an example portion of the script template corresponding to the maximum user duration is provided below:
MaxUserDuration:

Type: Number

Default: 32400 #Maximum 16 hours, Minimum 10 minutes

MinValue: 600

MaxValue: 57600

Description: “Default: 9 hour workday.”

Additionally, the IT administrator of the bank may define parameters corresponding to a disconnect timeout. The disconnect timeout may be defined as an amount of time elapsed after a user terminates a streaming instance. As an example, if the user attempts to launch a new streaming instance, and the disconnect timeout is below a default time value, the previous streaming instance is restored for the user. If the secure partition 90 is located within the Amazon Web Services® Cloud Computing Services, an example portion of the script template corresponding to the disconnect timeout is provided below:
DisconnectTimeout:

Type: Number

Default: 10800 #Maximum 16 hours, Minimum 10 minutes

MinValue: 600

MaxValue: 57600

Description: The time after disconnection when a session is considered to have ended. If a user who was disconnected reconnects within this timeout interval, the user is connected back to their previous session.

The IT administrator of the bank may, using the script template, grant privileges for the execution configurator 60 to access the application streaming service 70 and/or a monitoring service 80. As an example, if the secure partition 90 is located within the Amazon Web Services® Cloud Computing Service, the IT administrator of the bank may grant these privileges using an Amazon Web Services® Identity and Access Management (IAM role). The IAM role controls access to the application streaming service 70 and/or the monitoring service 80 by defining a set of permissions of the execution configurator 60. The set of permissions may include, for example, accessing the application streaming service 70 and creating an autoscaling policy to be implemented by the monitoring service 80. If the secure partition 90 is located within the Amazon Web Services® Cloud Computing Services, an example portion of the script template corresponding to granting privileges for the execution configurator 60 to access the application streaming service 70 is provided below:

TopazAppStreamAutomationIAMRole:

Type: “AWS::IAM::Role”
Properties:

AssumeRolePolicyDocument:
Version: “2012-10-17”
Statement:

-

Effect: “Allow”
Principal:

Service:
- “ec2.amazonaws.com”
Action:
- “sts:AssumeRole”

Policies: #Modify IAM EC2 Role

-

PolicyName: !Join [“”, [!Ref “AWS::Region”,
“TopazAppStreamAutomationIAMRole”]]
PolicyDocument:

Version: “2012-10-17”
Statement:
-

Effect: “Allow”
Action: “appstream:*”
Resource: “*”

-

Effect: “Allow”
Action:

- “iam:GetRole”
- “iam:PassRole”

Resource: !Join [“”, [“arn:aws:iam::”,
!Ref “AWS::AccountId”, “:role/service-
role/ApplicationAutoScalingForAmazon
AppStreamAccess”]]
Effect: “Allow”
Action: #Policy actions for appstream
configset

- application-
autoscaling:RegisterScalableTarg
et”
- application-
autoscaling:PutScalingPolicy
-cloudwatch:PutMetricAlarm

Resource: “*”

TopazAppStreamCloudFormationProfile:

Type: “AWS::IAM::InstanceProfile:
Properties:

Roles:

-

Ref: TopazAppStreamAutomationIAMRole”

While the above examples describe example portions of the script template when the secure partition 90 is located within the Amazon Web Services® Cloud Computing Services, these examples are non-limiting examples merely provided for illustration. It is understood by one of skill in the art that the example portions of the script template described above may be modified in response to the secure partition 90 being located within other cloud computing services.

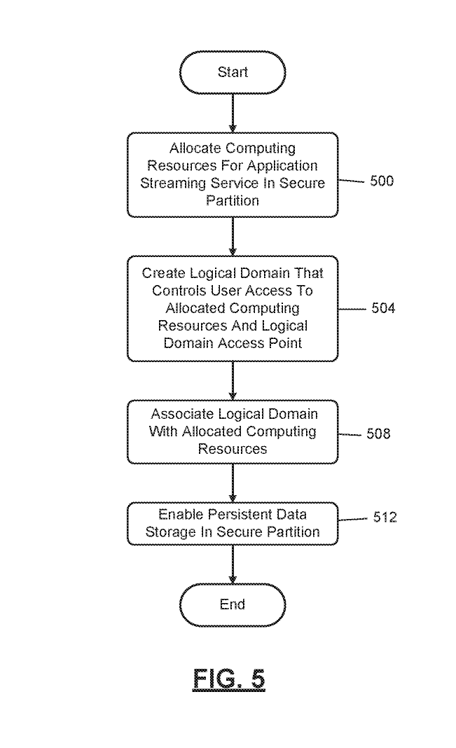

Further, the IT administrator of the bank may define parameters of the script template that enable the execution configurator 60 to configure the computing infrastructure that implements the application streaming service 70. Configuring the computing infrastructure may include, for example, selecting a geographical region to deploy the application streaming instance, allocating computing resources, creating a logical domain and logical domain access point, enabling persistent storage, and associating the logical domain with the allocated computing resources, as described below in further detail in FIGS. 5-6.

Additionally, the IT administrator of the bank may define parameters of the script template that configure the monitoring service 80 to implement an autoscaling policy for any given streaming instance deployed by the application streaming service 70. By implementing the autoscaling policy, the monitoring service 80 monitors the amount of allocated computing resources that the client devices 30 are consuming at a given time. The monitoring service 80 may trigger an alarm, send notifications, and/or terminate/create streaming instances based on the amount of allocated computing resources 90 being consumed by the client devices 30. Example autoscaling policies are described below in further detail in FIG. 7.

Once the parameters are defined for the script template, the execution configurator 60 generates a script based on the parameters defined by the administrator in the script template. In response to the execution configurator 60 generating a script, the computing resources in the secure partition 90 execute the script immediately thereafter. Executing the script configures the computing infrastructure that implements the application streaming service 70, configures a monitoring service 80 to implement the autoscaling policy for any given application instance deployed by the application streaming service 70, and enables the administrator to access a web-based streaming instance of the mainframe development application 40-3.

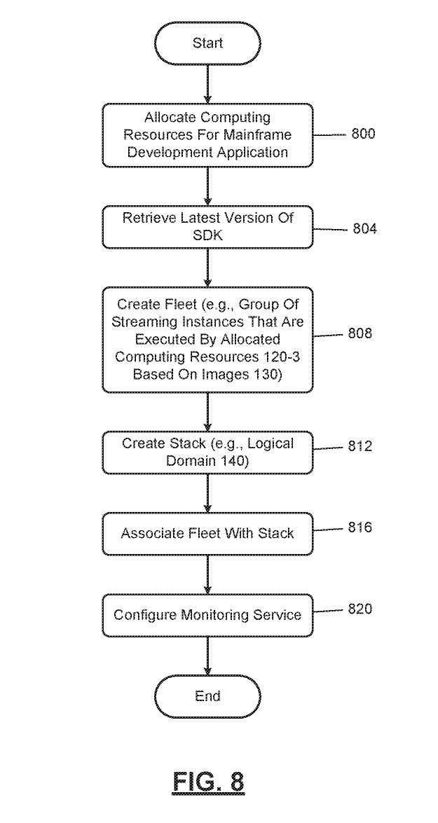

The script may be executed in a particular order to ensure that the application streaming service 70 is able to perform all functions defined in the script. As an example, the script may initially include instructions to retrieve the latest software development kit (SDK) of the application streaming service 70 before executing the remainder of the script, thereby ensuring that the application streaming service 70 is able to perform all functions defined in the script. An example order of executing the script is described below in FIG. 8.

FIG. 5 describes an algorithm for configuring the computing infrastructure that implements the application streaming service 70. The algorithm begins at 500, where the execution configurator 60 allocates computing resources for the application streaming service 70 in the secure partition 90 of the cloud computing environment 50. Allocating computing resources is described below in further detail in FIG. 6. At 504, the execution configurator 60 creates a logical domain that is configured to control end user access to the allocated computing resources. Additionally, the execution configurator 60 creates a logical domain access point from which the end users access the allocated computing resources. The logical domain is described below in further detail in FIG. 6. At 508, the execution configurator 60 associates the logical domain with the allocated computing resources, which is described below in further detail in FIG. 6. At 512, the execution configurator 60 enables persistent data storage in the secure partition 90 of the cloud computing environment 50, thereby enabling a mainframe developer to store work product created using the mainframe development application 40-3.

FIG. 6 illustrates a block diagram of computing resources 120 of the secure partition 90. As described above, in response to executing the script, the execution configurator 60 configures computing resources 120 of the secure partition 90, which may initially include allocating computing resources for the application streaming service 70 in the secure partition 90.

In one example embodiment, the computing resources 120 are implemented by a plurality of computing resource partitions, which include computing resource partitions 120-1, 120-2. Each of the plurality of computing resource partitions includes varying combinations of CPU, memory, storage, and networking capacity. Accordingly, allocating computing resources for the application streaming service 70 includes designating one or more of the plurality of computing resource partitions to implement the application streaming service 70. As shown in FIG. 6, allocated computing resources 120-3 of the computing resources 120 is designated as the computing resource partition that implements the application streaming service 70.

As an example, if the secure partition 90 is located within the Amazon Web Services® Cloud Computing Services, the allocated computing resources 120-3 may be implemented by various Amazon EC2 instance types provided by the Amazon Web Services® Amazon EC2 service. Example Amazon EC2 instance types include a T2 instance type, an M5 instance type, an M4 instance type, and an M3 instance type. Each of these Amazon EC2 instance types may also include various models (e.g., t2.micro, t2.nano, etc.) that implement varying combinations of CPU, memory, storage, and networking capacity. A portion of the script corresponding to allocating computing resources in the secure partition 90 is provided below:

EC2:

Type: “AWS::EC2::Instance”
Properties:

ImageID: !FindInMap [RegionMap, !Ref “AWS::Region”,
AMALINUX]
InstanceType: t2.micro
IamInstanceProfile: !Ref TopazAppStreamCloudformationProfile
KeyName: topaz_automation
UserData:

“Fn::Base64”:
!Sub

#!/bin/bash
yum update -y aws-cfn-bootstrap
yum -y update
pip install --upgrade awscli
/opt/aws/bin/cfn-init -v --stack ${AWS::StackName}
--resource EC2
--configsets appstream --region ${AWS::Region}

While the above example describes a portion of the script corresponding to allocating computing resources when the secure partition 90 is located within the Amazon Web Services® Cloud Computing Services, this example is non-limiting and merely is provided for illustration. It is understood by one of skill in the art that the portion of the script described above may be modified in response to the secure partition 90 being located within other cloud computing services.

The allocated computing resources 120-3 are configured to generate a group of streaming instances (e.g., fleet) based on image 130-1. The image 130-1 may include information that causes the allocated computing resources 120-3 to, for example, execute and stream the mainframe development application 40-3 (e.g., Topaz Workbench provided by Compuware®) to client devices 30.

Furthermore, as described above, configuring the computing infrastructure includes creating, using the execution configurator 60, a logical domain 140 that controls end user access to the allocated computing resources 120-3. The logical domain 140 includes instructions that designate preferences and access policies for users, such as the mainframe developers of the bank. As an example, the administrator may designate which mainframe developers can view streaming instances generated by the allocated computing resources 120-3, create streaming instances using the allocated computing resources 120-3, and/or delete streaming instances generated by the allocated computing resources 120-3. The logical domain 140 may be implemented by a stack of the Amazon Web Services® cloud computing service. The logical domain 140 may be accessed via a logical domain access point, which may be a web browser executing on the client devices 30 that uses a hyperlink associated with the logical domain 140.

In response to creating the logical domain 140, the execution configurator 60 may subsequently associate the allocated computing resources 120-3 with the logical domain 140, thereby enabling the administrator to apply the user access policies defined by the logical domain 140 to the allocated computing resources 120-3. Additionally or alternatively, the execution configurator may also enable persistent data storage in the secure partition 90, thereby enabling a mainframe developer to store work product created using the mainframe development application 40-3.

In FIG. 7, a flowchart describing an algorithm for a simple scaling policy is shown. The simple scaling policy may be defined as an autoscaling policy that scales active streaming instances such that the number of active streaming instances remains within a current capacity (i.e., a value between a maximum threshold and a minimum threshold). In one example embodiment, the algorithm may be executed by the monitoring service 80 and the application streaming service 70. Alternatively, the algorithm may be solely executed by the application streaming service 70 or the monitoring service 80.

At 700, the monitoring service 80 triggers a scaling event, which is defined as an event associated with at least one of launching a new streaming instance and terminating an active streaming instance. Moreover, in response to a scaling event, the monitoring service 80 may adjust an active streaming instance counter of the application streaming service 70 based on whether a streaming instance was generated or deleted.

At 704, the monitoring service 80 determines whether the number of active streaming instances is below a minimum threshold number of active streaming instances. If so, the algorithm proceeds to 708; otherwise, the algorithm proceeds to 712. At 708, the application streaming service 70 launches a new streaming instance. After launching a new streaming instance, the algorithm returns to 704.

At 712, the monitoring service 80 determines whether the number of active streaming instances is above a maximum threshold number of active streaming instances. If so, the algorithm proceeds to 716, and the application streaming service 70 terminates an active streaming instance. As an example, the application streaming service 70 may terminate active streaming instances that are impaired and/or unhealthy. If the number of active streaming instances is below the maximum threshold number of active streaming instances, the algorithm ends.

In other embodiments, the monitoring service 80 may execute different autoscaling policies. As an example, the monitoring service 80 may be configured to perform a target tracking scaling policy, which is based on a metric and target values designated by the administrator. As another example, the monitoring service 80 may be configured to perform a step scaling policy, which is configured to change, based on the amount of computing resources being utilized, a current capacity (i) by a specified number of streaming instances, (ii) to a specified number of streaming instances, or (iii) by a specified percentage of streaming instances.

As a more specific example, the step scaling policy may have a current capacity of ten streaming instances, an absolute maximum threshold of fifty streaming instances, a step value of five streaming instances, and a fifty percent threshold. Thus, once the monitoring service 80 detects five active streaming instances (i.e., 50% of the current capacity), the application streaming service 70 generates five additional streaming instances, therefore raising the current capacity to fifteen streaming instances. Subsequently, once the monitoring service 80 detects seven or eight active streaming instances (i.e., 50% of the current capacity), the application streaming service 70 generates five additional streaming instances, raising the current capacity to twenty streaming instances. The step scaling policy may be repeated until the current capacity reaches the absolute maximum threshold, which is fifty in this example.

FIG. 8 describes a flowchart of an example order of steps that the script executes in the secure partition 90. As an example, this method may be executed if the secure partition 90 is located within the Amazon Web Services® Cloud Computing Services. The method begins at 800, where the script allocates computing resources for the mainframe development application 40-3, as described above in FIGS. 5-6.

At 804, the script retrieves the latest version of the SDK of the application streaming service 70. As described above, retrieving the latest version of the SDK ensures that the application streaming service 70 is able to perform all functions defined in the script. Further, retrieving the latest version of the SDK provides the script access, via a command-line interface of the latest version of the SDK, to the application programming interface (API) features of the application streaming service 70. By providing the script access to the API features of the application streaming service 70, the script is able to execute commands that configure the computing infrastructure that implements the application streaming service 70, such as creating a fleet, creating a stack, and associating the stack and fleet, as described below.

At 808, the script creates a fleet (i.e., a group of streaming instances that are executed by the allocated computing resources 120-3 based on the images 130). At 812, the script creates a stack, which is an example logical domain 140, and the script creates the stack as described above in FIG. 6. At 816, the script associates the fleet with the stack, as described above in FIG. 6. If the secure partition 90 is located within the Amazon Web Services® Cloud Computing Services, an example portion of the script corresponding to steps 804-816 is provided below:

create_appstream:

commands:
01_aws_sdk_config:

cwd: “/opt”
Command: !Sub
aws configure set default.region ${AWS::Region} && aws
configure set
default.output json

02_create_fleet:

cwd: “/opt”
Command: aws appstream create-fleet --cli-input-json
file://topaz_appstream_create_fleet.json

03_create_stack:

cwd: “/opt”
Command: aws appstream create-stack --cli-input-json
file://topaz_appstream_create_fleet.json

04_associate_stream:

cwd: “/opt”
Command: !Sub
aws appstream associate-fleet --fleet-name ${Name}-Fleet
--stack-name
${Name}-Stack

While the above example describes a portion of the script corresponding to steps 804-816 when the secure partition 90 is located within the Amazon Web Services® Cloud Computing Services, this example is non-limiting and merely is provided for illustration. It is understood by one of skill in the art that the portion of the script described above may be modified in response to the secure partition 90 being located within other cloud computing services.

At 820, the script configures the monitoring service 80 by implementing an autoscaling policy for any given application instance deployed by the application streaming service 70, such as the simple scaling policy described in FIG. 7.

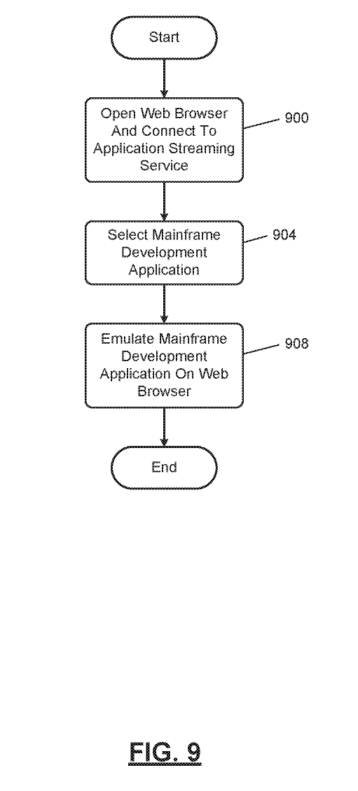

In FIG. 9, a flowchart describing an algorithm for a client device 30 interacting with a given instance of the application streaming service 70 is shown. The algorithm begins at 900, where a mainframe developer, using one of the client devices 30, may open a web browser and connect to the application streaming service 70. In one example embodiment, the mainframe developer may connect to the application streaming service 70 using the logical domain access point. At 904, the mainframe developer, using one of the client devices 30, selects the mainframe development application 40-3, and the application streaming service 70 emulates the mainframe development application 40-3 on the web browser of the respective client device 30 at 908.

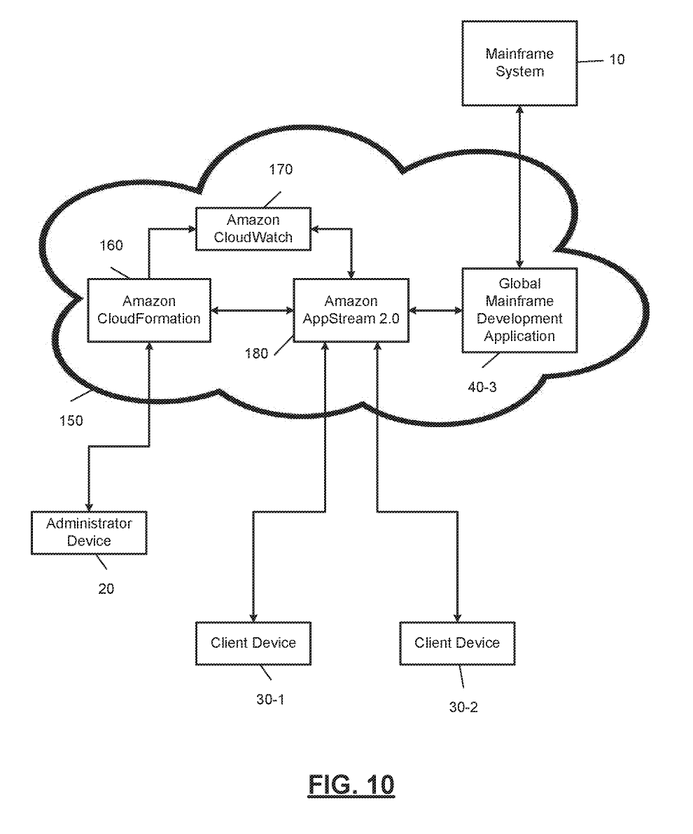

Turning to FIG. 10, a block diagram of an example mainframe development system using an example cloud computing environment 150 is shown. In one example embodiment, the cloud computing environment 150 may be implemented by the Amazon Elastic Compute Cloud (EC2) provided by Amazon Web Services®.

The administrator, using the administrator device 20, may deploy, using Amazon CloudFormation service 160 provided by Amazon Web Services®, a mainframe development application 40-3 (e.g., Topaz Workbench provided by Compuware®) via Amazon Appstream 2.0 service 180 provided by Amazon Web Services®. Mainframe developers, using the client devices 30, may then access the mainframe development application 40-3 by simply using a web browser.

The Amazon CloudFormation service 160 provided by Amazon Web Services® is configured to provide mainframe developers and administrators the ability to create and manage templates, and any dependencies or runtime parameters associated with the templates, which configure the computing infrastructure of the cloud computing environment 150. Additionally, the Amazon CloudFormation 160 provided by Amazon Web Services® can deploy and/or update a template and its associated collection of resources by using an application programming interface (API), such as JSON or YAML templates.

The Amazon Appstream 2.0 service 180 provided by Amazon Web Services® is configured to stream a mainframe development application 40-3 to the client devices 30 via an HTML5 web browser of the client devices 30. The Amazon Appstream 2.0 service 180 provided by Amazon Web Services® may stream the mainframe development application 40-3 to the client devices 30 for mainframe development regardless of an operating system type of the client devices 30 (e.g., Microsoft Windows®, Unix®, OS X®, and Linux®). Additionally, the Amazon Appstream 2.0 service 180 provided by Amazon Web Services® enables administrators to maintain a single version of the mainframe development application (i.e., the mainframe development application 40-3) for every mainframe developer and provide remote access to the mainframe development application 40-3.

Furthermore, the Amazon Appstream 2.0 service 180 provided by Amazon Web Services® provides a secure working environment for mainframe developers, as applications and data remain on the cloud computing environment 50. In other words, the Amazon Appstream 2.0 service 180 provided by Amazon Web Services® may stream encrypted pixels to the client devices 30, and the mainframe development application 40-3 is executed using a streaming instance dedicated to a corresponding mainframe developer, thereby ensuring that computing resources are not shared.

An Amazon CloudWatch service 170 provided by Amazon Web Services® monitors an amount of computing resources the client devices 30 are consuming at a given time. As an example, the monitoring service may measure and provide metrics corresponding to CPU utilization, data transfer, and disk usage activity of the instances generated by the cloud computing environment 150.

Furthermore, the Amazon CloudWatch service 170 provided by Amazon Web Services® may be configured to set alarms based on an autoscaling policy, which may be defined as an algorithm for scaling the amount of computing resources of the cloud computing environment 150 based on a number of active instances. In response to triggering an alarm, the monitoring service may send notifications and/or terminate/create instances based on the autoscaling policy.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A computer-implemented method for emulating a mainframe development application in a secure partition of computing resources in a cloud computing environment, comprising:
granting privileges for an execution configurator to access services in the secure partition of the cloud computing environment, where the services include an application streaming service that emulates the mainframe development application on a web browser and the execution configurator resides in the cloud computing environment;
instantiating, by the execution configurator, a given instance of the application streaming service in the secure partition of the computing resources, where the application streaming service is accessible to an end user and the computing resources are provided by a resource provider; and
configuring, by the execution configurator, computing infrastructure which implements the application streaming service by generating a script and executing the script in the secure partition of the cloud computing environment, where the script interacts with the given instance of the application streaming service via a command-line interface of a software development kit for the application streaming service.

2. The method of claim 1, wherein configuring computing infrastructure further comprises:
selecting a geographical location of a server on which to deploy the application streaming service;
allocating computing resources for the application streaming service in the secure partition;
creating a logical domain that controls user access to allocated computing resources; and
associating the logical domain to the allocated computing resources.

3. The method of claim 2 wherein configuring computing infrastructure further comprises enabling persistent data storage in the secure partition for use by the application.

4. The method of claim 2 further comprising:
receiving, by the execution configurator, a scaling policy from the end user; and
formulating, by the execution configurator, one or more instructions for the script, where the one or more instructions define the scaling policy and where autoscaling of the given instance of the application streaming service is governed by the scaling policy.

5. The method of claim 4 further comprising configuring, by the script, a monitoring service to implement autoscaling of the given instance of the application streaming service in accordance with the scaling policy, where the monitoring service is associated with the allocated computing resources for the application streaming service and is distinct from the application streaming service.

6. The method of claim 2 further comprising:
emulating the mainframe development application, via the application streaming service, on one or more web browsers; and
autoscaling the allocated computing resources to the one or more web browsers in accordance with a scaling policy.

7. The method of claim 2 further comprises accessing the logical domain on a web browser using a hyperlink to the logical domain.

8. The method of claim 2 further comprising accessing the logical domain on a web browser using a hyperlink to the logical domain.

9. The method of claim 2 wherein executing the script further comprises:
in response to determining that a new version of the software development kit exists, retrieving, using the execution configurator, the new version of the software development kit; and
executing the script based on the new version of the software development kit.

10. The method of claim 9 wherein executing the script based on the new version of the software development kit further comprises:
creating one or more instances that are executed by the allocated computing resources;
associating the one or more streaming instances with the logical domain; and
configuring a monitoring service to implement autoscaling of the given instance of the application streaming service in accordance with a scaling policy.

11. A system for emulating a mainframe development application in a secure partition of computing resources in a cloud computing environment, the system comprising:
an execution configurator residing in the cloud computing environment, where the execution configurator is implemented by one or more processors that are configured to execute instructions stored in a non-transitory computer-readable medium, and where the instructions include:
granting privileges for an execution configurator to access services in the secure partition of the cloud computing environment, where the services include an application streaming service that emulates the mainframe development application on a web browser;
instantiating a given instance of the application streaming service in the secure partition of the computing resources, where the application streaming service is accessible to an end user and the computing resources are provided by a resource provider; and
configuring computing infrastructure which implements the application streaming service by generating a script and executing the script in the secure partition of the cloud computing environment, where the script interacts with the given instance of the application streaming service via a command-line interface of a software development kit for the application streaming service.

12. The system of claim 11 wherein configuring computing infrastructure further comprises:
selecting a geographical location of a server on which to deploy the application streaming service;
allocating computing resources for the application streaming service in the secure partition;
creating a logical domain that controls user access to allocated computing resources; and
associating the logical domain to the allocated computing resources.

13. The system of claim 12 wherein configuring computing infrastructure further comprises enabling persistent data storage in the secure partition for use by the application.

14. The system of claim 12 wherein the instructions further comprise:
receiving a scaling policy from the end user; and
formulating one or more instructions for the script, where the one or more instructions define the scaling policy and autoscaling of the given instance of the application streaming service is governed by the scaling policy.

15. The system of claim 14 wherein the instructions further comprise configuring, by the script, a monitoring service to implement autoscaling of the given instance of the application streaming service in accordance with the scaling policy, where the monitoring service is associated with the allocated computing resources for the application streaming service and is distinct from the application streaming service.

16. The system of claim 14 wherein the instructions further comprise:
emulating the mainframe development application, via the application streaming service, on one or more web browsers; and
autoscaling the allocated computing resources to the one or more web browsers in accordance with a scaling policy.

17. The system of claim 12 wherein the instructions further comprise accessing the logical domain on a web browser using a hyperlink to the logical domain.

18. The system of claim 12 wherein executing the script further comprises:
in response to determining that a new version of the software development kit exists, retrieving, using the execution configurator, the new version of the software development kit; and
executing the script based on the new version of the software development kit.

19. The system of claim 18 wherein executing the script based on the new version of the software development kit further comprises:
creating one or more instances that are executed by the allocated computing resources;
associating the one or more streaming instances with the logical domain; and
configuring a monitoring service to implement autoscaling of the given instance of the application streaming service in accordance with a scaling policy.
